(19) United States
(12) Patent Application Publication
(10) Pub. No.: US 2019/0155097 A1
(43) Pub. Date: May 23, 2019

(54) DISPLAY DEVICE

(71) Applicant: SHARP KABUSHIKI KAISHA, Sakai City (JP)

(72) Inventor: NARU USUKURA, Sakai City (JP)

(21) Appl. No.: 16/197,182

(22) Filed: Nov. 20, 2018

(30) Foreign Application Priority Data
Nov. 22, 2017 (JP) 2017-224728

(51) Int. Cl. G02F 1/1335; G02F 1/13363; G02F 1/1334

(52) U.S. Cl. CPC G02F 1/133536; G02F 1/13363; G02F 1/133504; G02F 2001/133543; G02F 2203/64; G02F 2001/133638; G02F 2001/133541; G02F 1/1334

(57) ABSTRACT

The present invention provides a display device that is excellent in designability and allows a reflection color in the non-display state to be less likely to appear differently at different viewing positions. The display device includes, in the following order: a display panel capable of switching between a display mode of emitting display light and a non-display mode of not emitting display light; a λ/4 retardation layer; a circularly polarized light ray reflection layer; and a light scattering layer capable of switching between a light scattering mode of scattering incident light and a light transmitting mode of transmitting incident light. The circularly polarized light ray reflection layer preferably contains a cholesteric liquid crystal.

### CROSS-REFERENCE TO RELATED APPLICATIONS

The present application claims priority under 35 U.S.C. § 119 to Japanese Patent Application No. 2017-224728 filed on Nov. 22, 2017, the contents of which are incorporated herein by reference in their entirety.

### BACKGROUND OF THE INVENTION

### Field of the Invention

The present invention relates to display devices. In particular, the present invention relates to a display device favorably usable even in a non-display state.

### Description of Related Art

Display devices such as liquid crystal display devices only present a black screen in a non-display state and thus require improvement in designability. Here, proposed is a mirror display including a half mirror layer disposed on the front surface side of a display device, thereby imparting a function as a mirror to the display device (e.g., WO 2015/141350).

### BRIEF SUMMARY OF THE INVENTION

WO 2015/141350 discloses a mirror display including, in the following order: a liquid crystal display device, a reflective polarizing plate as a half mirror layer, and a light-diffusing member. WO 2015/141350 states that such a mirror display can match the surrounding environment having diffuse reflection surfaces in the mirror mode. However, the present inventors found through studies that the light-diffusing member (e.g., polymer dispersed liquid crystal display panel) scatters incident light forward and backward to cause insufficient reflectance, making it difficult to display a reflection color with a high reflectance (i.e., sufficiently bright color). The inventors also found that the reflection color tends to appear differently at different viewing positions despite the existence of the reflective polarizing plate (e.g., multilayer reflective polarizing plate, wire grid reflective polarizing plate) in the mirror display, because such a reflective polarizing plate reflects a linearly polarized light ray with a large anisotropy.

The present invention has been made under the current situation in the art and aims to provide a display device that is excellent in designability and allows a reflection color in the non-display state to be less likely to appear differently at different viewing positions.

The present inventors have made various studies on display devices that are excellent in designability and allow a reflection color in the non-display state to be less likely to appear differently at different viewing positions. The inventors thereby found that disposing a λ/4 retardation layer and a circularly polarized light ray reflection layer between a display panel and a light scattering layer enables the reflection color in the non-display state to be less likely to appear differently at different viewing positions. The inventors thus arrived at a solution to the above problem, completing the present invention.

In other words, an aspect of the present invention may be a display device including, in the following order: a display panel capable of switching between a display mode of emitting display light and a non-display mode of not emitting display light; a λ/4 retardation layer; a circularly polarized light ray reflection layer; and a light scattering layer capable of switching between a light scattering mode of scattering incident light and a light transmitting mode of transmitting incident light.

The present invention can provide a display device that is excellent in designability and allows a reflection color in the non-display state to be less likely to appear differently at different viewing positions.

### BRIEF DESCRIPTION OF THE DRAWINGS

FIG. 1 is a schematic cross-sectional view of a display device of Embodiment 1.

FIG. 2 is a schematic cross-sectional view illustrating the operation principle of the display state in the display device of Embodiment 1.

FIG. 3 is a schematic cross-sectional view illustrating the operation principle of the non-display state in the display device of Embodiment 1.

FIG. 4 is a schematic plan view of a display device of Embodiment 2.

FIG. 5 is a schematic plan view of a display device of Embodiment 3.

FIG. 6 is a schematic plan view of a display device of a modified example of Embodiment 3.

FIG. 7 is a schematic plan view of a display device of Embodiment 4.

### DETAILED DESCRIPTION OF THE INVENTION

The present invention is described below in more detail based on embodiments with reference to the drawings. The embodiments, however, are not intended to limit the scope of the present invention. The configurations employed in the embodiments may appropriately be combined or modified within the spirit of the present invention.

The following embodiments exemplarily present cases where the display panel is a liquid crystal display panel, but the display panel may be of any type.

The phrase “X to Y” herein means X or more and Y or less.

### Embodiment 1

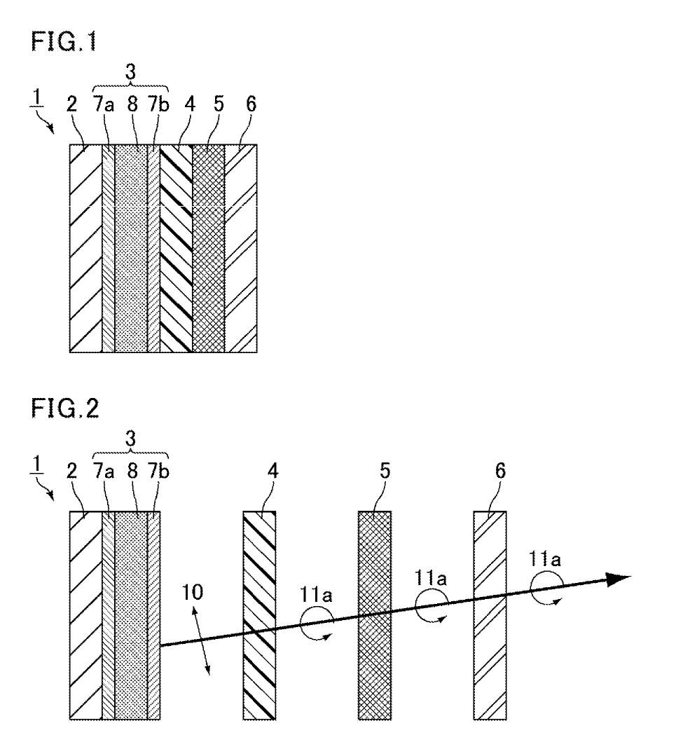

The following is the description of a display device of Embodiment 1 with reference to FIG. 1. FIG. 1 is a schematic cross-sectional view of a display device of Embodiment 1.

A display device 1 includes, in the following order: a backlight 2, a liquid crystal display panel 3, a λ/4 retardation layer 4, a circularly polarized light ray reflection layer 5, and a light scattering layer 6.

### <Backlight>

The backlight 2 may be a conventionally known backlight. The type of the backlight 2 is not particularly limited and examples thereof include an edge light backlight and a direct-lit backlight. The light source of the backlight 2 may be of any type such as light emitting diodes (LEDs) and cold cathode fluorescent lamps (CCFLs).

### <Liquid Crystal Display Panel>

The liquid crystal display panel 3 can switch between the display mode of emitting display light and the non-display mode of not emitting display light. Examples of display light include linearly polarized light rays, circularly polarized light rays, and elliptically polarized light rays. Display light may be in such a polarization state as described above or in an unpolarized state where various polarization states are randomly included. The following describes an exemplary configuration of the liquid crystal display panel 3 that includes, in the following order as shown in FIG. 1: an absorptive polarizing plate 7a, a liquid crystal cell 8, and an absorptive polarizing plate 7b.

The absorptive polarizing plates 7a and 7b each may be a product formed by dyeing a polyvinyl alcohol (PVA) film with an anisotropic material such as an iodine complex (or dye) to adsorb the anisotropic material on the PVA film and then stretch-aligning the film.

The liquid crystal cell 8 may be a cell including paired substrates and a liquid crystal layer held between the substrates. Examples of the combination for the substrates include a conventionally known combination of a thin transistor array substrate and a color filter substrate.

The liquid crystal display panel 3 can switch between the display mode of transmitting light emitted from the backlight 2 through the liquid crystal display panel 3 (absorptive polarizing plate 7b) to the λ/4 retardation layer 4 side as a linearly polarized light ray (display light) and the non-display mode of not transmitting the light through the liquid crystal display panel 3 (absorptive polarizing plate 7b) to the λ/4 retardation layer 4 side as a linearly polarized light ray (display light) by, for example, selecting the combination of the positional relationship between the transmission axes (absorption axes) of the absorptive polarizing plates 7a and 7b and the alignment state of liquid crystal molecules in the liquid crystal cell 8. In a liquid crystal display panel 3 that is a normally black type liquid crystal display panel, when the liquid crystal cell 8 (liquid crystal layer) is in the voltage-applied state, a linearly polarized light ray (display light) passes through the liquid crystal display panel 3 (absorptive polarizing plate 7b) to the λ/4 retardation layer 4 side (display mode). Meanwhile, when the liquid crystal cell 8 (liquid crystal layer) is in the no-voltage-applied state, a linearly polarized light ray (display light) does not pass through the liquid crystal display panel 3 (absorptive polarizing plate 7b) to the λ/4 retardation layer 4 side (non-display mode). In a liquid crystal display panel 3 that is a normally white type liquid crystal display panel, when the liquid crystal cell 8 (liquid crystal layer) is in the voltage-applied state, a linearly polarized light ray (display light) does not pass through the liquid crystal display panel 3 (absorptive polarizing plate 7b) to the λ/4 retardation layer 4 side (non-display mode). Meanwhile, when the liquid crystal cell 8 (liquid crystal layer) is in the no-voltage-applied state, a linearly polarized light ray (display light) passes through the liquid crystal display panel 3 (absorptive polarizing plate 7b) to the λ/4 retardation layer 4 side (display mode). When the liquid crystal display panel 3 is operated in the non-display mode, the backlight 2 may be turned on or off.

### <λ/4 Retardation Layer>

The λ/4 retardation layer 4 is a retardation layer imparting in-plane retardation of a ¼ wavelength (λ/4) to incident light with a wavelength of λ.

The λ/4 retardation layer 4 may be formed of a photopolymerizable liquid crystal material. The photopolymerizable liquid crystal material may contain a photopolymerizable group such as an acrylate group or methacrylate group at an end of the skeleton of a liquid crystal molecule.

The λ/4 retardation layer 4 can be formed by the following method. First, a photopolymerizable liquid crystal material is dissolved in an organic solvent such as propyleneglycol monomethyl ether acetate (PGMEA). The resulting solution is applied to a surface of a substrate (e.g., polyethylene terephthalate (PET) film) to form a coating film of the solution. The coating film of the solution is sequentially pre-baked, irradiated with light (e.g., ultraviolet rays), and post-baked to form the λ/4 retardation layer 4.

The λ/4 retardation layer 4 may also be a polymer film having undergone stretch treatment. The polymer film may be formed of a material such as a cycloolefin polymer, polycarbonate, polysulfone, polyethersulfone, polyethylene terephthalate, polyethylene, polyvinyl alcohol, norbornene, triacetyl cellulose, and diacetyl cellulose.

### <Circularly Polarized Light Ray Reflection Layer>

The circularly polarized light ray reflection layer 5 reflects one of an incident right circularly polarized light ray and an incident left circularly polarized light ray and transmits the other. The circularly polarized light ray reflected by the circularly polarized light ray reflection layer 5 has a small anisotropy, thereby enabling the reflection color to be less likely to appear differently at different viewing positions.

The circularly polarized light ray reflection layer 5 preferably contains a cholesteric liquid crystal. The cholesteric liquid crystal has a helical structure and may be formed by adding a chiral agent to a nematic liquid crystal. Here, use of a photoreactive chiral agent as the chiral agent and photoreaction of the agent and a photopolymerization initiator achieve formation of a cholesteric liquid crystal with a desired helical pitch (helical period).

The cholesteric liquid crystal selectively reflects a circularly polarized light ray whose wavelength is equal to the helical pitch and whose rotation direction is the same as the twist direction of the helix. Namely, the helical pitch of the cholesteric liquid crystal varies the wavelength of the reflected light to achieve free adjustment of the reflection color.

### <Light Scattering Layer>

The light scattering layer 6 can switch between the light scattering mode of scattering incident light and the light transmitting mode of transmitting incident light. The light scattering layer 6 may have a configuration including paired electrodes and a polymer dispersed liquid crystal (PDLL) held between the electrodes from the circularly polarized light ray reflection layer 5 side and the opposite side of the circularly polarized light ray reflection layer 5.

The polymer dispersed liquid crystal includes microdroplets of liquid crystal dispersed in a polymer matrix. The polymer dispersed liquid crystal may be formed by irradiating a mixture of a nematic liquid crystal and a photocurable resin with light and thereby polymerizing the photocurable resin.

In the polymer dispersed liquid crystal in the no-voltage-applied state (the state where no voltage is applied between the paired electrodes), dispersed liquid crystal (microdroplets) with different alignment vectors face different directions to allow the light scattering mode (opaque state) of scattering incident light at the interfaces in the liquid crystal. In contrast, in the polymer dispersed liquid crystal in the voltage-applied state (the state where voltage is applied between the paired electrodes), the liquid crystal and the polymer have similar refractive indices to allow the light transmitting mode (transparent state) of transmitting incident light.

The following is the description of the operation principles of the display state and non-display state of the display device 1. The following is an exemplary case where the circularly polarized light ray reflection layer 5 contains a cholesteric liquid crystal and the light scattering layer 6 contains a polymer dispersed liquid crystal.

### <Display State>

FIG. 2 is a schematic cross-sectional view illustrating the operation principle of the display state in the display device of Embodiment 1. In FIG. 2, the liquid crystal display panel 3, the λ/4 retardation layer 4, the circularly polarized light ray reflection layer 5, and the light scattering layer 6 are illustrated with spaces therebetween for convenience.

In the display device 1 operated in the display state, the liquid crystal display panel 3 is set to the display mode and, as shown in FIG. 2, light emitted from the backlight 2 passes through the liquid crystal display panel 3 (absorptive polarizing plate 7b) to the λ/4 retardation layer 4 side as a linearly polarized light ray 10 (display light: an image provided by the liquid crystal display panel 3). The linearly polarized light ray 10 vibrates in the azimuth parallel to the transmission axis of the absorptive polarizing plate 7b.

The linearly polarized light ray 10 emerging from the liquid crystal display panel 3 passes through the λ/4 retardation layer 4 to be converted into a circularly polarized light ray 11a. The circularly polarized light ray 11a may be a right circularly polarized light ray or a left circularly polarized light ray, which is appropriately decided according to the positional relationship between the transmission axis of the absorptive polarizing plate 7b and the in-plane slow axis of the λ/4 retardation layer 4 (the angle formed by the axes: approximately 45°).

Here, in the circularly polarized light ray reflection layer 5, the twist direction of the helix of the cholesteric liquid crystal is designed differently from the rotation direction of the circularly polarized light ray 11a. Accordingly, the circularly polarized light ray 11a incident on the circularly polarized light ray reflection layer 5 can pass through the circularly polarized light ray reflection layer 5.

The circularly polarized light ray 11a emerging from the circularly polarized light ray reflection layer 5 passes through the light scattering layer 6 set to the light transmitting mode (voltage-applied state) and is emitted from the display device 1 in the end.

As described above, in the display device 1 operated in the display state, emitted light from the display device 1 is viewed, and thus an image provided by the liquid crystal display panel 3 is visible.

### <Non-Display State>

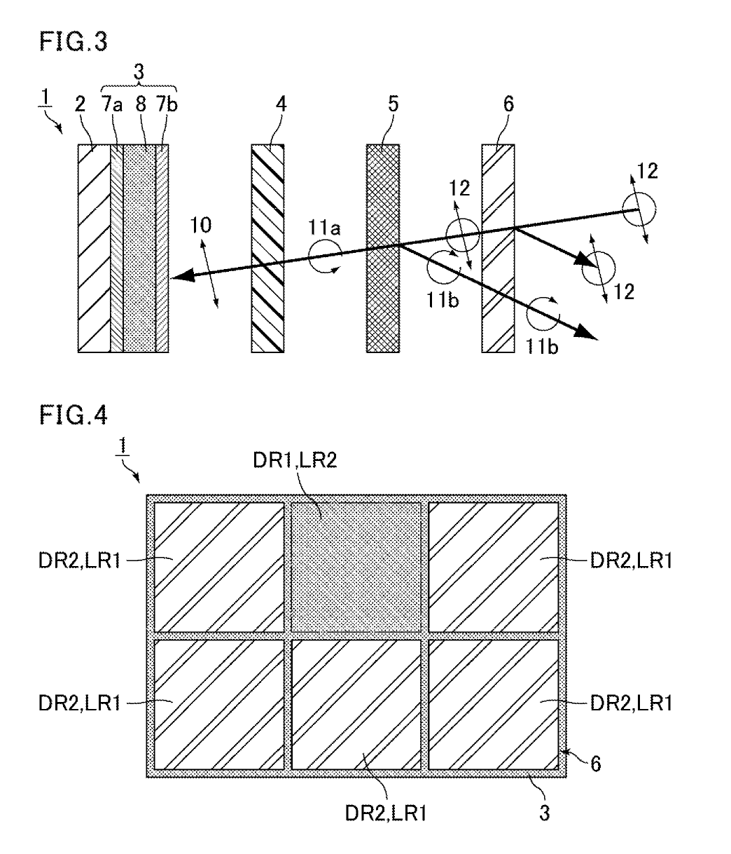

FIG. 3 is a schematic cross-sectional view illustrating the operation principle of the non-display state in the display device of Embodiment 1. In FIG. 3, the liquid crystal display panel 3, the λ/4 retardation layer 4, the circularly polarized light ray reflection layer 5, and the light scattering layer 6 are illustrated with spaces therebetween for convenience.

In the display device 1 operated in the non-display state, the liquid crystal display panel 3 is set to the non-display mode and, as shown in FIG. 3, external light 12 (unpolarized light) incident on the display device 1 from the light scattering layer 6 side is scattered by the light scattering layer 6 set to the light scattering mode (no-voltage-applied state) toward the circularly polarized light ray reflection layer 5 and the opposite side of the circularly polarized light ray reflection layer 5.

Here, in the circularly polarized light ray reflection layer 5, the twist direction of the helix of the cholesteric liquid crystal is designed differently from the rotation direction of the circularly polarized light ray 11a (one of a right circularly polarized light ray and a left circularly polarized light ray) as described and is designed to be the same as the rotation direction of the circularly polarized light ray 11b (the other of the right circularly polarized light ray and the left circularly polarized light ray). Thus, among the components of the external light 12 scattered by the light scattering layer 6 toward the circularly polarized light ray reflection layer 5, the circularly polarized light ray 11a passes through the circularly polarized light ray reflection layer 5, while the circularly polarized light ray lib is reflected by the circularly polarized light ray reflection layer 5 to the light scattering layer 6 side.

The circularly polarized light ray 11a emerging from the circularly polarized light ray reflection layer 5 passes through the λ/4 retardation layer 4 to be converted into the linearly polarized light ray 10 and is then appropriately absorbed by the liquid crystal display panel 3 and the backlight 2. The circularly polarized light ray 11b reflected by the circularly polarized light ray reflection layer 5 toward the light scattering layer 6 is scattered by the light scattering layer 6 set to the light scattering mode (no-voltage-applied state).

Accordingly, in the display device 1 operated in the non-display state, reflected light (scattered light) of the display device 1 is viewed and thus the display device 1 appears colored according to the reflection color. Additionally, the display device 1 achieves display of a reflection color with a high reflectance (i.e., sufficiently bright color) by the effect of the circularly polarized light ray reflection layer 5, thereby enabling the reflection color in the non-display state to be less likely to appear differently at different viewing positions. Moreover, the display device 1 operated in the non-display state can match the surrounding environment having diffuse reflection surfaces by the effect of the light scattering layer 6, thereby achieving excellent designability.

As described above, the display device 1 operated in the non-display state appears colored according to the reflection color. The reflection color may be freely adjusted as below, for example.

### Adjustment Example 1

The circularly polarized light ray reflection layer 5 may reflect the circularly polarized light ray lib with any wavelength falling within the wavelength range of visible light (typically 380 nm to 780 nm). Thereby, the display device 1 appears white in the non-display state. Such a state may be achieved by, in the circularly polarized light ray reflection layer 5, continuously varying the helical pitch of the cholesteric liquid crystal so as to allow the helical pitch to cover the whole wavelength range of visible light.

### Adjustment Example 2

The circularly polarized light ray reflection layer 5 may reflect the circularly polarized light ray lib with a wavelength in part of the wavelength range of visible light. Thereby, the display device 1 appears in a certain color other than white in the non-display state. For example, when the helical pitch of the cholesteric liquid crystal in the circularly polarized light ray reflection layer 5 is adjusted to 500 nm to 600 nm, the display device 1 appears green in the non-display state.

### Adjustment Example 3

The circularly polarized light ray reflection layer 5 may include regions that reflect different circularly polarized light rays 11b with different wavelengths from each other. Thereby, the circularly polarized light ray reflection layer 5 provides patterned reflection colors, which enables the display device 1 to display fixed letter(s) or image(s) in the non-display state. Such a state may be achieved by, in the circularly polarized light ray reflection layer 5, changing the helical pitch of the cholesteric liquid crystal among the regions.

Unlike the present embodiment, in the case of using a reflective polarizing plate such as a multilayer reflective polarizing plate or a wire grid reflective polarizing plate in place of the circularly polarized light ray reflection layer 5, the wavelength of the linearly polarized light ray to be reflected is less likely to be controlled, causing difficulty in free adjustment of the reflection color.

As described above, in the display device 1 operated in the non-display state, light (circularly polarized light ray lib) reflected by the circularly polarized light ray reflection layer 5 is viewed. In order to suppress reflection of things such as the viewer's face and the surrounding environment (e.g., lighting), the circularly polarized light ray reflection layer 5 preferably has light scattering reflection property. This enables the circularly polarized light ray reflection layer 5 to reflect and scatter the circularly polarized light ray 11b in the display device 1 operated in the non-display state. Thereby, the things such as the viewer's face and the surrounding environment (e.g., lighting) are less reflected than in the case where the circularly polarized light ray lib is simply specularly reflected.

Examples of the method for imparting light scattering reflection property to the circularly polarized light ray reflection layer 5 include a method of performing photo-alignment treatment to vary the pre-tilt angle of the cholesteric liquid crystal in different regions. Specifically, an alignment film (polyimide film) is formed on at least one of the facing surfaces of the λ/4 retardation layer 4 and of the light scattering layer 6. Then, photo-alignment treatment in which the alignment film is irradiated with linearly polarized ultraviolet rays from an oblique direction with part of the alignment film being shielded with a light-shielding mask is repeatedly performed while the light-shielded part of the alignment film is changed. Next, a layer containing a cholesteric liquid crystal is disposed as the circularly polarized light ray reflection layer 5 between the λ/4 retardation layer 4 and the light scattering layer 6. Thereby, the pre-tilt angle of the cholesteric liquid crystal can be varied (e.g., −10°, 0°, 10°) in different regions (e.g., the order of several micrometers or less).

### Embodiment 2

The following is the description of a display device of Embodiment 2 with reference to FIG. 4. FIG. 4 is a schematic plan view of a display device of Embodiment 2. The display device of Embodiment 2 is the same as the display device of Embodiment 1 except that the liquid crystal display panel includes divided regions and the light scattering layer includes divided regions. Thus, the description of the same respects is omitted here. In FIG. 4, only the liquid crystal display panel 3 and the light scattering layer 6 of the display device 1 are illustrated for convenience. In FIG. 4, in order to simply illustrate the positional relationship between the liquid crystal display panel 3 and the light scattering layer 6, their frames are shifted from each other, but the frames may be at the same position. The same shall apply to FIGS. 5 to 7 described later.

The liquid crystal display panel 3 includes divided regions involving a display region DR1 in the display mode and non-display regions DR2 in the non-display mode. Such a state may be achieved by using a local dimming backlight as the backlight 2. The local dimming backlight includes light sources (light emitting regions) in respective divided regions, and the light sources can be separately turned on (with a certain luminance) or off for each region. The local dimming backlight provides the liquid crystal display panel 3 with a function by which certain region(s) is/are operated in the display mode while the other region(s) is/are operated in the non-display mode simultaneously in the same plane.

The light scattering layer 6 includes divided regions involving light scattering regions LR1 in the light scattering mode and a light transmitting region LR2 in the light transmitting mode. Such a state may be achieved by, for example, disposing a polymer dispersed liquid crystal and paired electrodes for applying voltage to the polymer dispersed liquid crystal in each of the divided regions. Then, each pair of electrodes is separately set to the no-voltage-applied state or voltage-applied state. This provides the light scattering layer 6 with a function by which certain region(s) is/are operated in the light scattering mode while the other region(s) is/are operated in the light transmitting mode simultaneously in the same plane.

In the display device 1, the display region DR1 and the light transmitting region LR2 are superimposed on each other and the non-display regions DR2 and the light scattering regions LR1 are superimposed on each other. Thereby, the display device 1 can display an image provided by the liquid crystal display panel 3 in the region where the display region DR1 and the light transmitting region LR2 are superimposed on each other (display state). Meanwhile, the display device 1 appears colored according to the reflection color in the regions where the non-display regions DR2 and the light scattering regions LR1 are superimposed on each other (non-display state). Thereby, the display device 1 can match the surrounding environment (e.g., the casing of the display device 1).

FIG. 4 presents an exemplary configuration where the liquid crystal display panel 3 and the light scattering layer 6 each include six quadrangular (substantially square) divided regions arranged in a matrix of two rows and three columns. The number, shape, and arrangement of the divided regions are not particularly limited. For example, the number of the divided regions may be larger than six, and the divided regions may have an abnormal shape excepting a quadrangular shape and may be arranged in a matrix excepting a matrix with two rows and three columns.

### Embodiment 3

The following is the description of a display device of Embodiment 3 with reference to FIG. 5. FIG. 5 is a schematic plan view of a display device of Embodiment 3. The display device of Embodiment 3 is the same as the display device of Embodiment 1 except that the light scattering layer includes divided regions when the liquid crystal display panel is operated in the non-display mode. Thus, the description of the same respects is omitted here.

When the liquid crystal display panel 3 is operated in the non-display mode, the light scattering layer 6 includes divided regions involving the light scattering regions LR1 in the light scattering mode and the light transmitting regions LR2 in the light transmitting mode. Thereby, in the display device 1 operated in the non-display state, pattern(s) like letter(s) emerge in the light scattering regions LR1 or the light transmitting regions LR2 of the light scattering layer 6 (in FIG. 5, the light transmitting regions LR2).

In the present embodiment, the circularly polarized light ray reflection layer 5 preferably reflects different circularly polarized light rays with different wavelengths between in the regions superimposed on the light scattering regions LR1 and in the regions superimposed on the light transmitting regions LR2. Thereby, reflection colors provided by the circularly polarized light ray reflection layer 5 are different between in the regions superimposed on the light scattering regions LR1 and in the regions superimposed on the light transmitting regions LR2 so that pattern(s) like letter(s) emerge more clearly in the display device 1 operated in the non-display state.

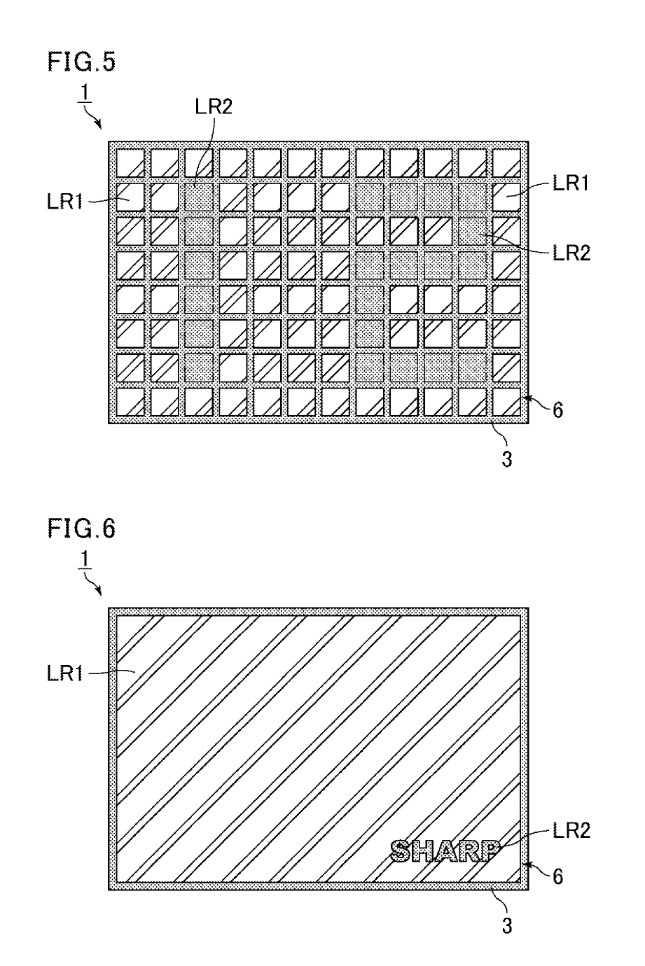

The divided regions of the light scattering layer 6 may be formed by a similar method to that in Embodiment 2. Alternatively, as a modified example as shown in FIG. 6, regions with the polymer dispersed liquid crystal may be used as the light scattering regions LR1 while regions without the polymer dispersed liquid crystal may be used as the light transmitting region LR2. FIG. 6 is a schematic plan view of a display device of a modified example of Embodiment 3. Also in the present modified example, in the display device 1 operated in the non-display state, pattern(s) like letter(s) emerge in the light scattering regions LR1 or the light transmitting regions LR2 of the light scattering layer 6 (in FIG. 6, the light transmitting regions LR2).

### Embodiment 4

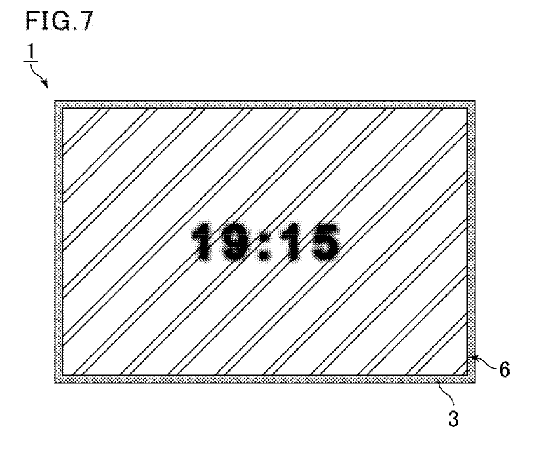

The following is the description of a display device of Embodiment 4 with reference to FIG. 7. FIG. 7 is a schematic plan view of a display device of Embodiment 4. The display device of Embodiment 4 is the same as the display device of Embodiment 1 except that the light scattering layer is in the light scattering mode when the liquid crystal display panel is operated in the display mode. Thus, the description of the same respects is omitted here.

When the liquid crystal display panel 3 is operated in the display mode, the light scattering layer 6 is in the light scattering mode. Thereby, in the display device 1 operated in the display state, an image provided by the liquid crystal display panel 3 is visible although the image is slightly blurred due to the act (scattering) of the light scattering layer 6. In the present embodiment, similarly to the non-display state, the light scattering layer 6 is set to the light scattering mode (no-voltage-applied state) in the display device 1 operated in the display state, which achieves more power saving than in Embodiment 1. Similarly to Embodiment 2, the light scattering layer 6 may also include divided regions in the present embodiment.

Embodiments 1 to 4 present exemplary cases where the light scattering layer 6 contains a polymer dispersed liquid crystal. The light scattering layer 6 may be formed by a combination of a polymer dispersed liquid crystal and a light diffuser (e.g., a conventionally known product in which beads are kneaded in a substrate).

### [Additional Remarks]

An aspect of the present invention may be a display device including, in the following order: a display panel capable of switching between a display mode of emitting display light and a non-display mode of not emitting display light; a λ/4 retardation layer; a circularly polarized light ray reflection layer; and a light scattering layer capable of switching between a light scattering mode of scattering incident light and a light transmitting mode of transmitting incident light. This aspect achieves a display device that is excellent in designability and allows a reflection color in the non-display state to be less likely to appear differently at different viewing positions.

The light scattering layer may contain a polymer dispersed liquid crystal. This enables effective use of the light scattering layer.

The circularly polarized light ray reflection layer may contain a cholesteric liquid crystal. This enables effective use of the circularly polarized light ray reflection layer. Here, the circularly polarized light ray reflection layer may reflect a circularly polarized light ray with a wavelength in part of the wavelength range of visible light. This enables the display device to appear in a certain color other than white in the non-display state. Also, the circularly polarized light ray reflection layer may include regions that reflect different circularly polarized light rays with different wavelengths from each other. This enables the display device to display fixed letter(s) or image(s) in the non-display state.

The circularly polarized light ray reflection layer may have light scattering reflection property. This can suppress reflection of things such as the viewer's face and the surrounding environment (e.g., lighting) in the display device operated in the non-display state.

The display panel may include divided regions involving a display region in the display mode and a non-display region in the non-display mode, the light scattering layer may include divided regions involving a light scattering region in the light scattering mode and a light transmitting region in the light transmitting mode, the display region and the light transmitting region may be superimposed on each other, and the non-display region and the light scattering region may be superimposed on each other. This enables the display device to display an image provided by the display panel (display state) in the region where the display region and the light transmitting region are superimposed on each other. This also enables the display device to appear colored according to the reflection color (non-display state) in the region where the non-display region and the light scattering region are superimposed on each other and thereby to match the surrounding environment (e.g., the casing of the display device).

When the display panel is operated in the non-display mode, the light scattering layer may include divided regions involving a light scattering region in the light scattering, mode and a light transmitting region in the light transmitting mode. This enables pattern(s) like letter(s) to emerge in the light scattering region or the light transmitting region of the light scattering layer in the display device operated in the non-display state. Here, the circularly polarized light ray reflection layer may reflect different circularly polarized light rays with different wavelengths between in a region superimposed on the light scattering region and in a region superimposed on the light transmitting region. This enables pattern(s) like letter(s) to emerge more clearly in the display device operated in the non-display state.

When the display panel is operated in the display mode, the light scattering layer may be in the light scattering mode. This enables that, in the display device operated in the display state, an image provided by the display panel is visible although the image is slightly blurred due to the act (scattering) of the light scattering layer.

The display panel may be a liquid crystal display panel. This enables the present invention to be applicable to the case where a liquid crystal display panel is used as the display panel. The display panel may be of any type such as, in addition to liquid crystal display panels, organic electroluminescence display panels and plasma display panels. Such a display panel can also switch between the display mode of emitting display light (typically unpolarized light) and the non-display mode of not emitting display light.

What is claimed is:

1. A display device comprising, in the following order:
a display panel capable of switching between a display mode of emitting display light and a non-display mode of not emitting display light;
a λ/4 retardation layer;
a circularly polarized light ray reflection layer; and
a light scattering layer capable of switching between a light scattering mode of scattering incident light and a light transmitting mode of transmitting incident light.

2. The display device according to claim 1,
wherein the light scattering layer contains a polymer dispersed liquid crystal.

3. The display device according to claim 1,
wherein the circularly polarized light ray reflection layer contains a cholesteric liquid crystal.

4. The display device according to claim 3,
wherein the circularly polarized light ray reflection layer reflects a circularly polarized light ray with a wavelength in part of the wavelength range of visible light.

5. The display device according to claim 4,
wherein the circularly polarized light ray reflection layer includes regions that reflect different circularly polarized light rays with different wavelengths from each other.

6. The display device according to claim 1,
wherein the circularly polarized light ray reflection layer has light scattering reflection property.

7. The display device according to claim 1,
wherein the display panel includes divided regions involving a display region in the display mode and a non-display region in the non-display mode,
the light scattering layer includes divided regions involving a light scattering region in the light scattering mode and a light transmitting region in the light transmitting mode,
the display region and the light transmitting region are superimposed on each other, and
the non-display region and the light scattering region are superimposed on each other.

8. The display device according to claim 1,
wherein, when the display panel is operated in the non-display mode, the light scattering layer includes divided regions involving a light scattering region in the light scattering mode and a light transmitting region in the light transmitting mode.

9. The display device according to claim 8,
wherein the circularly polarized light ray reflection layer reflects different circularly polarized light rays with different wavelengths between in a region superimposed on the light scattering region and in a region superimposed on the light transmitting region.

10. The display device according to claim 1,
wherein, when the display panel is operated in the display mode, the light scattering layer is in the light scattering mode.

11. The display device according to claim 1,
wherein the display panel is a liquid crystal display panel.
